(19) United States
(12) Patent Application Publication
(10) Pub. No.: US 2019/0145518 A1
(43) Pub. Date: May 16, 2019

(54) COUPLING MECHANISM

(71) Applicant: Electro-Motive Diesel, Inc., LaGrange, IL (US)

(72) Inventors: Amar Jeetendra Panchangam Nivarthi, Darien, IL (US); Jeffrey Paul Nowak, Munster, IN (US)

(73) Assignee: Electro-Motive Diesel, Inc., LaGrange, IL (US)

(21) Appl. No.: 15/815,541

(22) Filed: Nov. 16, 2017

(51) Int. Cl. F16J 15/10; F16J 15/06; F01M 13/04; F02F 11/00

(52) U.S. Cl. CPC F16J 15/104; F16J 15/062; F02M 61/14; F02F 11/002; F01M 13/0416

(57) ABSTRACT

A coupling mechanism for a sealing structure having interacting seals in non-parallel planes includes a male portion of a mechanical joint and a female portion of the mechanical joint. The male portion is coupled with a first sealing member contained in a first plane. The female portion is coupled with a second sealing member which is contained in a second plane. The second plane is different from the first plane. The male portion and the female portion of the mechanical joint are configured to mate for coupling the first sealing member with the second sealing member.

### TECHNICAL FIELD

The present disclosure relates to a sealing structure for a cover of an engine, and more particularly to a coupling mechanism associated with the sealing structure.

### BACKGROUND

Machines, such as those used in construction industries, include an engine to power various components of the machine. The engine includes a rocker arm cover which houses components, such as a rocker arm, a rocker shaft, intake valves, and exhaust valves of the engine. The rocker arm cover includes a cover body, a cover plate, and a number of sealing members. The rocker arm cover protects the rocker arms and also assures that lubricant oil, that lubricates the rocker arms and surrounding components, remains within a cylinder head of the engine.

Various designs of rocker arm covers are being developed to provide easy access to the components mounted inside the rocker arm cover for servicing or maintenance. Thus, the rocker arm covers have a split design including multiple sub-parts that are assembled to form a single rocker arm cover. Such rocker arm covers include multiple sealing members provided in different planes that allow sealing of the sub-parts of the rocker arm cover. The sealing members in the different planes need to be coupled to one another for an effective sealing of the sub-parts of the rocker arm cover.

U.S. Pat. No. 7,316,214 describes a cover for tightly sealing a device. The cover includes at least one elastomer part which is designed to fit tightly against a contact surface of a device. The cover also includes another part which follows the elastomeric part. The elastomeric part being arc-shaped in a transition area to the other part.

### SUMMARY OF THE DISCLOSURE

In one aspect of the present disclosure, a coupling mechanism for a sealing structure having interacting seals in non-parallel planes is provided. The coupling mechanism includes a male portion of a mechanical joint. The male portion is coupled with a first sealing member contained in a first plane. The coupling mechanism also includes a female portion of the mechanical joint. The female portion is coupled with a second sealing member which is contained in a second plane. The second plane is different from the first plane. The male portion and the female portion of the mechanical joint are configured to mate for coupling the first sealing member with the second sealing member.

In another aspect of the present disclosure, a sealing structure for a rocker arm cover of an engine is provided. The sealing structure includes a first sealing member contained in a first plane. The sealing structure also includes a second sealing member configured to couple to the first sealing member. The second sealing member is contained in a second plane. The first plane and the second plane are perpendicular to each other. The sealing structure further includes a coupling mechanism for coupling the first sealing member with the second sealing member. The coupling mechanism includes a male portion of a mechanical joint. The male portion is coupled with the first sealing member. The coupling mechanism also includes a female portion of the mechanical joint. The female portion is coupled with the second sealing member. The male portion is configured to mate with the female portion for coupling the first sealing member with the second sealing member.

In yet another aspect of the present disclosure, an engine is provided. The engine includes a rocker arm cover. The rocker arm cover includes a first cover portion and a second cover portion. The engine also includes a sealing structure at least one of the first cover portion with the second cover portion and the rocker arm cover with a surface of the engine. The sealing structure includes a first sealing member contained in a first plane. The sealing structure also includes a second sealing member configured to couple to the first sealing member. The second sealing member is contained in a second plane. The first plane and the second plane are perpendicular to each other. The sealing structure further includes a coupling mechanism for coupling the first sealing member with the second sealing member. The coupling mechanism includes a male portion of a mechanical joint. The male portion is coupled with the first sealing member. The coupling mechanism also includes a female portion of the mechanical joint. The female portion is coupled with the second sealing member. The male portion is configured to mate with the female portion for coupling the first sealing member with the second sealing member.

Other features and aspects of this disclosure will be apparent from the following description and the accompanying drawings.

### BRIEF DESCRIPTION OF THE DRAWINGS

FIG. 1 is a side view of a portion of an exemplary engine, according to one embodiment of the present disclosure;

FIG. 2 is a perspective view of a rocker arm cover associated with the engine of FIG. 1, according to one embodiment of the present disclosure;

FIG. 3 is a perspective view of a portion of the rocker arm cover illustrating a sealing structure associated with the rocker arm cover;

FIG. 4 is a schematic view of a mechanical joint associated with a coupling mechanism of the sealing structure, according to one embodiment of the present disclosure;

FIG. 5 is a perspective of a male portion of the mechanical joint of FIG. 4, according to one embodiment of the present disclosure;

FIG. 6 is a perspective view of another type of mechanical joint associated with the coupling mechanism of the sealing structure, according to another embodiment of the present disclosure;

FIG. 7 is a perspective view of an assembly cover and an oil pan associated with the engine of FIG. 1, according to one embodiment of the present disclosure; and

FIG. 8 is a perspective view of a cover assembly and a crack case associated with the engine of FIG. 1, according to another embodiment of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

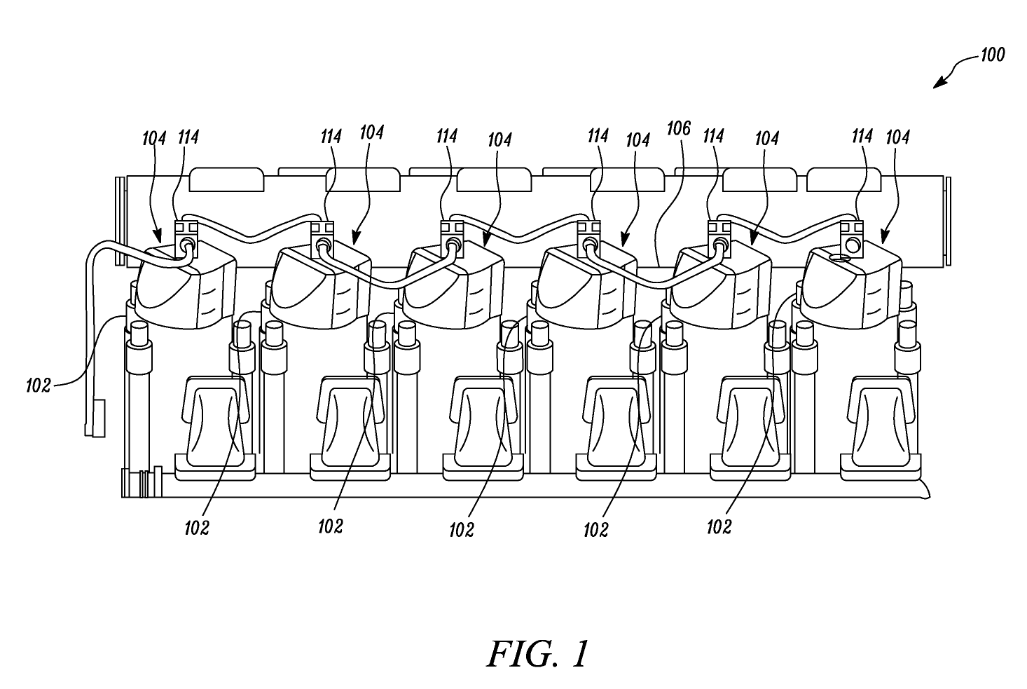

Referring to FIG. 1, an exemplary engine 100 is depicted. The engine 100 may be used to power a machine (not shown). The machine may be associated with an industry including, but not limited to, mining, construction, farming, earthmoving, or any another industry known in the art. Further, the machine may include any one of a locomotive, an excavator, a shovel, a loader, a truck, etc., without limiting the scope of the present disclosure.

The engine 100 may be an internal combustion engine, such as a reciprocating piston engine. Further, the engine 100 may be a spark ignition engine or a compression ignition engine, such as a diesel engine, a natural gas engine, a homogeneous charge compression ignition engine, a reactivity controlled compression ignition engine, or any other engine known in the art. The engine 100 may be fueled by one or a combination of gasoline, diesel fuel, biodiesel, dimethyl ether, alcohol, natural gas, propane, or any other combustion fuel known in the art.

In the illustrated embodiment, the engine 100 includes six in-line cylinders 102. Alternatively, the engine 100 may include any number of cylinders arranged in any configuration (V-type, in-line, radial, etc.), without limiting the scope of the disclosure. Each of the six-inline cylinders 102 includes various mechanical components (not shown) arranged to perform one or more functions associated with the engine 100. The mechanical components may include, but are not limited to, an intake valve, an exhaust valve, a rocker arm, and a rocker shaft.

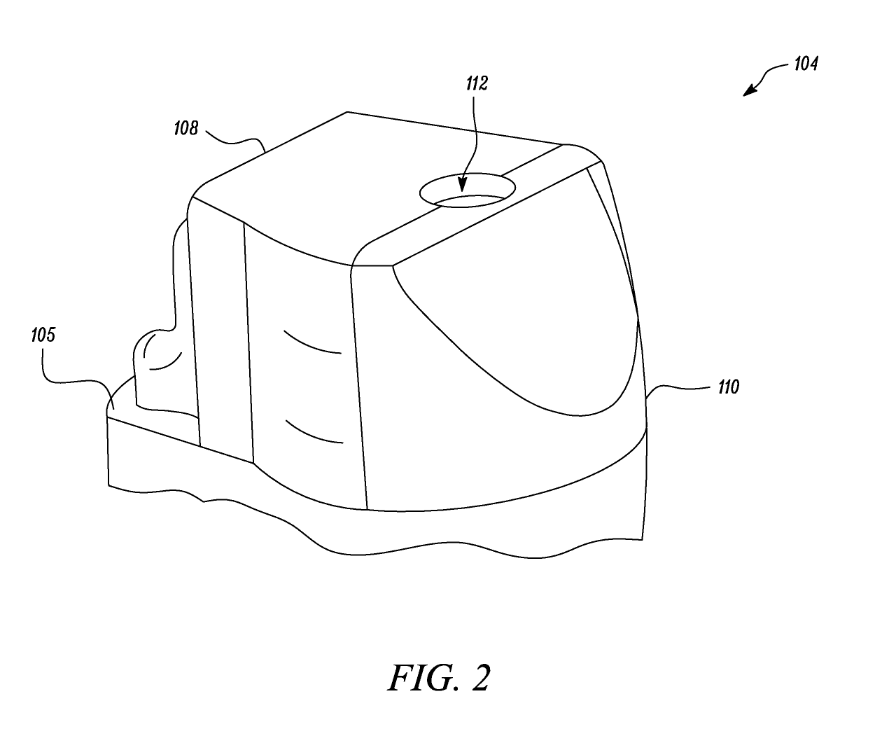

The engine 100 includes six rocker arm covers 104 associated with each of the six cylinders 102. The cylinders 102 are defined in an engine block 106. Each of the six rocker arm covers 104 is configured to cover and protect the mechanical components (not shown) of each of the six cylinders 102 of the engine 100. More specifically, a rocker arm cover 104 is mounted on the cylinder 102 of the engine 100, such that the rocker arm cover 104 covers the mechanical components of the respective cylinder 102. The rocker arm cover 104 couples with a surface 105 (see FIG. 2) of the cylinder 102 using a number of fastening members (not shown) including but not limited to, bolts, screws etc. It should be noted that the engine 100 may include a number of rocker arm covers 104 based on the number of cylinders 102, without limiting the scope of the disclosure.

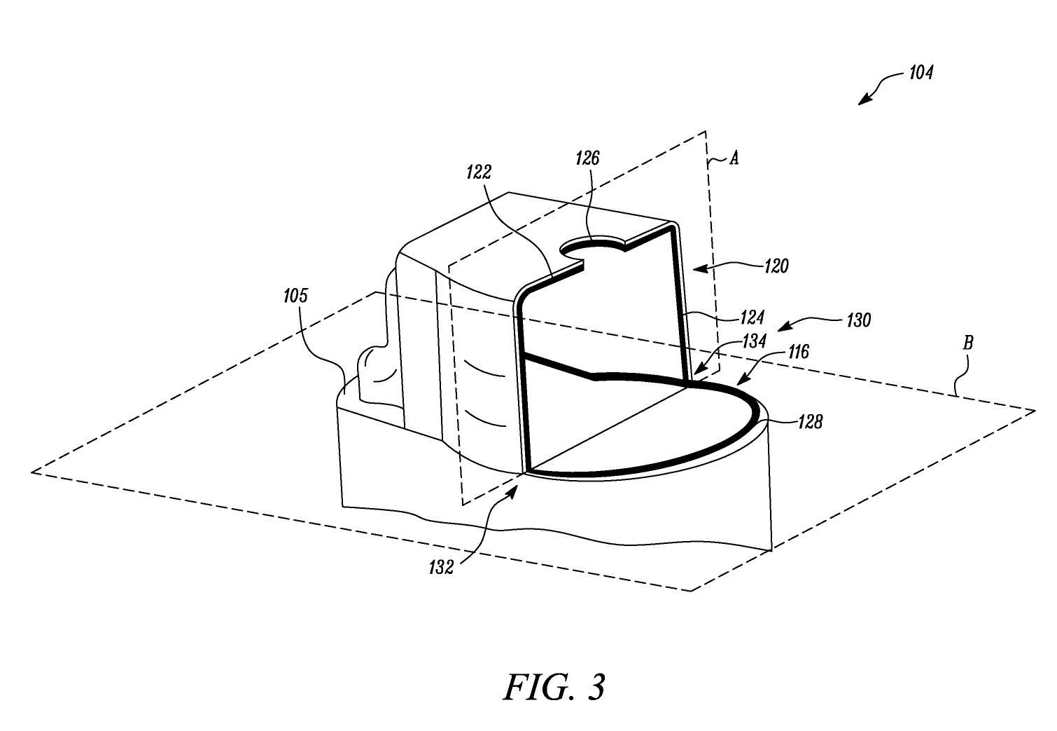

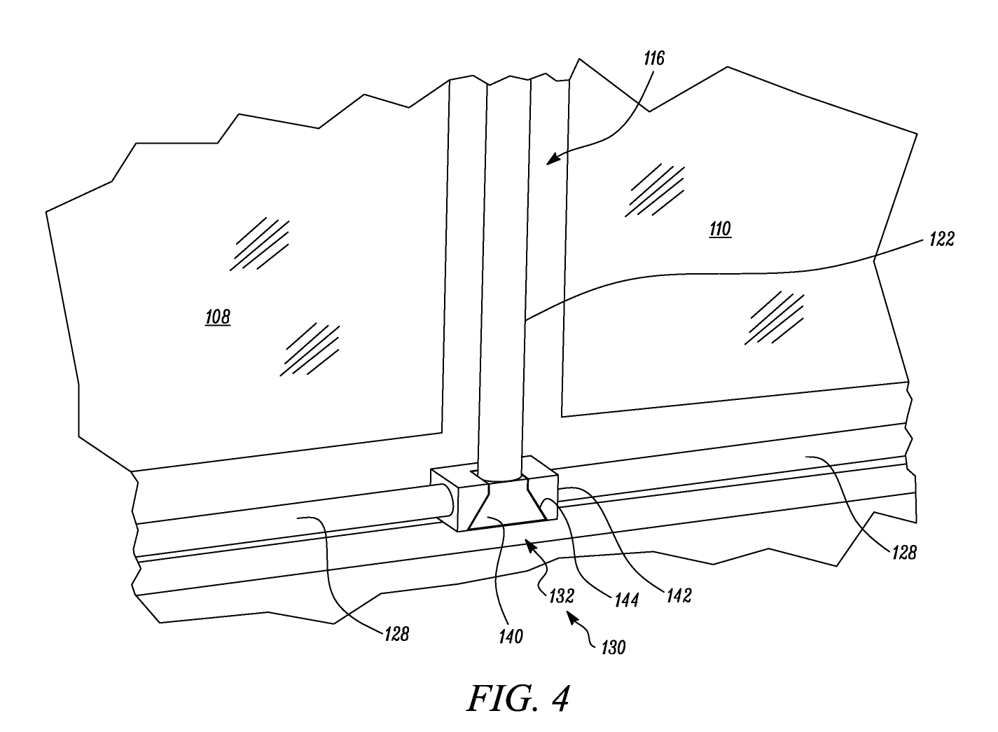

Referring to FIG. 2, a single rocker arm cover 104 of the engine 100 is depicted. The rocker arm cover 104 includes a first cover portion 108 and a second cover portion 110. The first and second cover portions 108, 110 are removably coupled to each other using a number of fastening members (not shown) including, but not limited to screws, bolts etc. During servicing and repairs, the second cover portion 110 may be removed to access the mechanical components of the engine 100. Further, the first cover portion 108 is sealed with the second cover portion 110 by a sealing structure 116 (see FIGS. 3 and 4). The sealing structure 116 will be explained in detail later in this section.

Generally, the first cover portion 108 and the second cover portion 110 are hollow hood structures made of casted aluminum materials. Alternatively, the first cover portion 108 and the second cover portion 110 may be made from steel, alloys, polymers, or the like, without limiting the scope of the disclosure.

The first and second cover portions 108, 110 are coupled to the surface 105 of the cylinder 102 of the engine 100, for mounting of the rocker arm cover 104. The first and second cover portions 108, 110 are sealed with the surface 105 of the cylinder 102 by the sealing structure 116.

Further, each of the first cover portion 108 and the second cover portion 110 includes one half of an orifice 112. More particularly, when the first cover portion 108 is coupled with the second cover portion 110, the first and second cover portions 108, 110 together define the orifice 112. A fuel injector 114 (see FIG. 1) is received within the orifice 112 to supply fuel to the cylinder 102 of the engine 100. Although the rocker arm cover 104 of the present disclosure includes two cover portions, the rocker arm cover 104 may include more than two cover portions based on the type of application, without limiting the scope of the present disclosure.

Referring to FIG. 3, the sealing structure 116 associated with the rocker arm cover 104 is illustrated. The sealing structure 116 seals the first cover portion 108 with the second cover portion 110. Further, the sealing structure 116 also seals the each of first and second cover portions 108, 110 with the surface 105 of the cylinder 102. The sealing structure 116 prevents leakage of lubricant oil from an interface of the first cover portion 108 and the second cover portion 110 and also from an interface of the rocker arm cover 104 and the cylinder 102.

Referring to FIGS. 3 and 4, the sealing structure 116 includes a pair of first sealing members 120. The pair of first sealing members 120 include a first seal 122 and a second seal 124. Each of the first and second seals 122, 124 are contained in a first plane “A”. When the first and second cover portions 108, 110 are coupled to each other, the first and second seals 122, 124 act as interposing seals provided between the first cover portion 108 and the second cover portion 110.

The sealing structure 116 also includes a second sealing member 128 contained in a second plane “B” that is different from the first plane “A”. The first and second planes “A”, “B” are embodied as non-parallel planes. In the illustrated example, the first plane “A” is perpendicular to the second plane “B”. The second sealing member 128 contained in the second plane “B” couples with the first sealing member 120 contained in the first plane “A”. The second sealing member 128 is an interposing seal between the surface 105 of the cylinder 102 and each of the first and second cover portions 108, 110, respectively. When the first and second cover portions 108, 110 are assembled, the second sealing member 128 runs or extends along an entire periphery of the assembled rocker arm cover 104.

The first sealing member 120 and the second sealing member 128 may be manufactured from an elastomeric material such as rubber, without any limitations. The sealing structure 116 further includes a third sealing member 126 provided at the orifice 112. The third sealing member 126 is contained in a plane (not shown) that may be parallel to the second plane “B”. The third sealing member 126 surrounds and seals with the fuel injector 114. In one example, the first, second, and third sealing members 120, 128, 126 may be embodied as O-rings. Further, the first, second, and third sealing members 120, 128, 126 may include any one of a square cross-section, a rectangular cross-section, an oval cross-section, etc., without any limitations.

Referring now to FIG. 3, the sealing structure 116 includes a coupling mechanism 130. The coupling mechanism 130 couples the first sealing members 120 with the second sealing member 128. Further, the coupling mechanism 130 also seals the first sealing members 120 with the third sealing member 126. The coupling mechanism 130 includes a number of mechanical joints. The coupling mechanism 130 may be associated with any sealing structure having interacting seals in non-parallel planes, without limiting the scope of the disclosure.

As shown in the accompanying figures, the mechanical joint 132 couples the first seal 122 of the first sealing member 120 with the second sealing member 128. The mechanical joint 134 couples the second seal 124 of the first sealing member 120 with the second sealing member 128. Further, a mechanical joint (not shown) couples the first seal 122 of the first sealing member 120 with the third sealing member 126, and another mechanical joint (not shown) couples the second seal 124 of the first sealing member 120 with the third sealing member 126. It should be noted that the sealing structure 116 may include more than four mechanical joints, based on system requirements.

For explanatory purposes, the mechanical joint 132 that couples the first seal 122 with the second sealing member 128 will now be described in detail with reference to FIG. 4. However, it should be noted that the description provided below is equally applicable to all the mechanical joints of the coupling mechanism 130, without any limitations. In the illustrated example, the mechanical joint 132 is a dovetail joint. More particularly, the mechanical joint 132 is a reverse dovetail joint. In another example, the mechanical joint 132 may include a half-blinded dovetail joint.

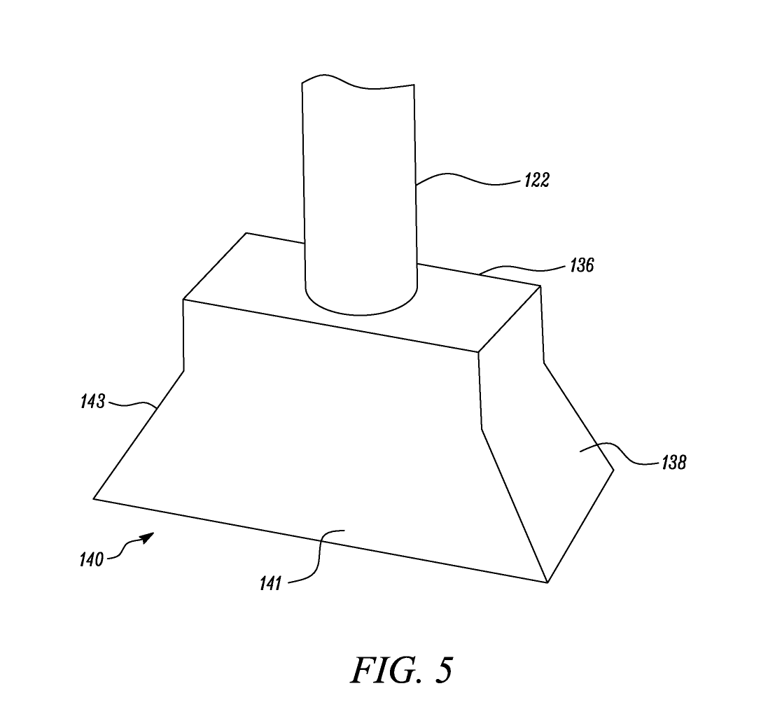

The mechanical joint 132 includes a male portion 140. The male portion 140 of the mechanical joint 132 is coupled with the first seal 122 of the first sealing member 120. In one example, the male portion 140 and the first sealing member 120 may be manufactured as a unitary component. Alternatively, the male portion 140 and the first sealing member 120 may be manufactured as separate components that may be assembled using any joining technique known in the art. Further, as shown in FIG. 5, the male portion 140 includes four faces 136, 138, 141, 143 out of which three faces 138, 141, 143 are embodied as sloped faces. The sloped faces 138, 141, 143 allow sealing on all three faces using the tension in the first seal 122.

Further, the mechanical joint 132 also includes a female portion 142. The female portion 142 of the mechanical joint 132 couples with the second sealing member 128. In one example, the female portion 142 and the second sealing member 128 may be manufactured as a unitary component. Alternatively, the female portion 142 and the second sealing member 128 may be manufactured as separate components that may be assembled using any joining technique known in the art. The female portion 142 includes a socket 144. A shape of the socket 144 corresponds to a shape of the male portion 140 of the mechanical joint 132.

During the coupling of the first seal 122 with the second sealing member 128, the male portion 140 of the mechanical joint 132 mates with the female portion 142. More specifically, the socket 144 receives the male portion 140 for coupling the first seal 122 with the second sealing member 128. The male portion 140 and the socket 144 may have a circular shape, a trapezoidal shape, or the like, without limiting the scope of the disclosure.

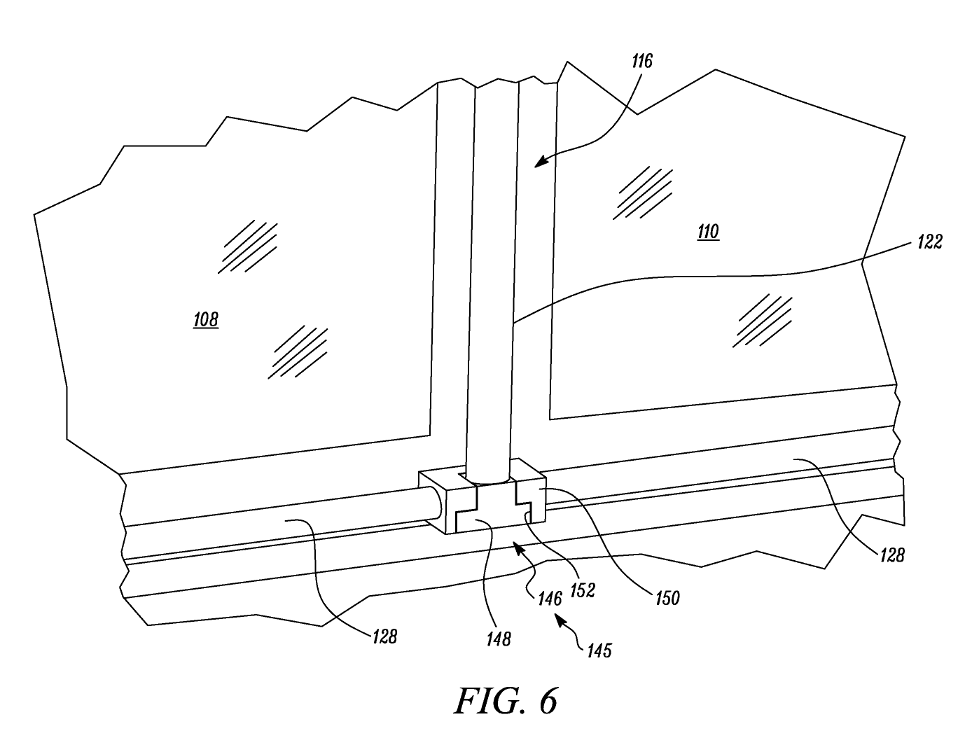

FIG. 6 illustrates the sealing structure 116 having the coupling mechanism 145. The coupling mechanism 145 includes another type of the mechanical joint 146 for connecting the first seal 122 with the second sealing member 128. The mechanical joint 146 is embodied as a T-joint. The mechanical joint 146 includes a male portion 148. The male portion 148 of the mechanical joint 146 is coupled with the first seal 122 of the first sealing member 120. The male portion 148 is T-shaped.

Further, the mechanical joint 146 also includes a female portion 150. The female portion 150 of the mechanical joint 146 couples with the second sealing member 128. The female portion 150 includes a T-shaped socket 152 corresponding to a shape of the male portion 148 of the mechanical joint 146. During the coupling of the first seal 122 with the second sealing member 128, the male portion 148 of the mechanical joint 146 mates with the female portion 150. More specifically, the socket 152 receives the male portion 148 for coupling the first seal 122 with the second sealing member 128.

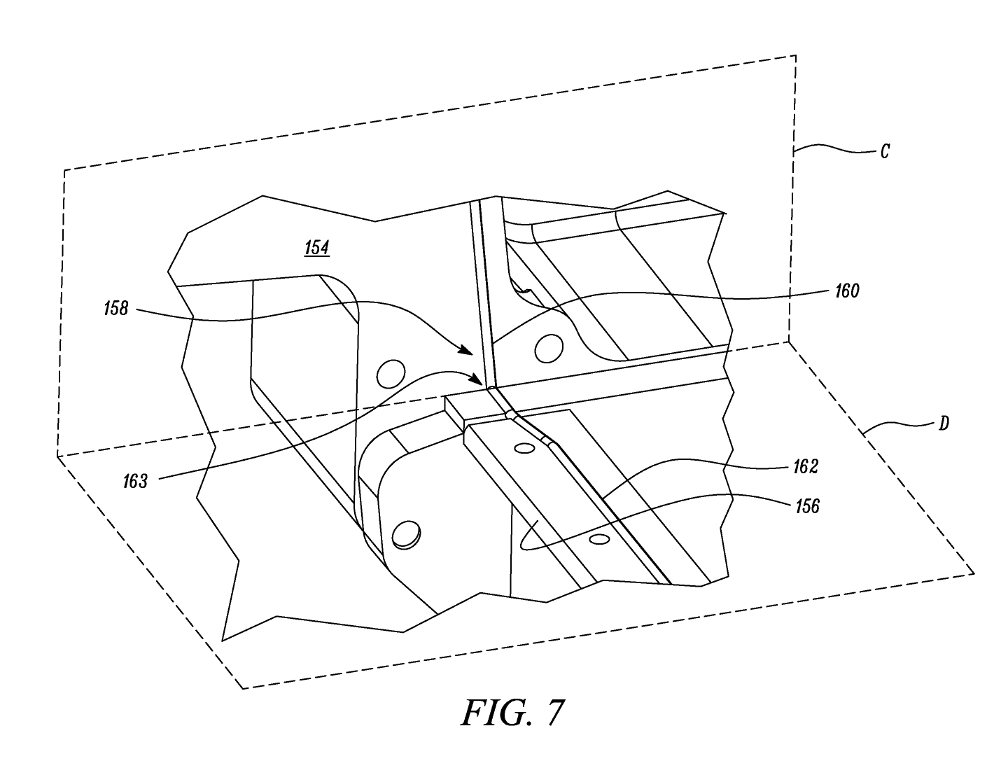

Although the present disclosure is explained in relation to the coupling of the sealing members 120, 128, 126 of the rocker arm cover 104, the teachings of the present disclosure may be extended to a variety of application areas, without any limitations. One such application area is shown in FIG. 7, where an accessory cover 154 associated with a crank case (not shown) and an oil pan 156 is depicted. The accessory cover 154 provides easy access to components of the crank case and the oil pan 156. The accessory cover 154 includes a sealing structure 158 that seals the accessory cover 154 with the crank case and also seals the accessory cover 154 with the oil pan 156.

The sealing structure 158 includes a first sealing member 160 associated with the accessory cover 154 and a second sealing member 162 disposed between the crank case and the oil pan 156. The first and second sealing members 160, 162 may be similar to the first, second, and third sealing members 120, 128, 126 disclosed earlier in this section. The first sealing member 160 of the accessory cover 154 is provided in a first plane “C” that is perpendicular to a second plane “D” in which the second sealing member 162 is provided. The first and second sealing members 160, 162 provided in the perpendicular planes “C”, “D” may be coupled using a coupling mechanism 163. The coupling mechanism 163 may be similar to the coupling mechanisms 130, 145 described in detail above.

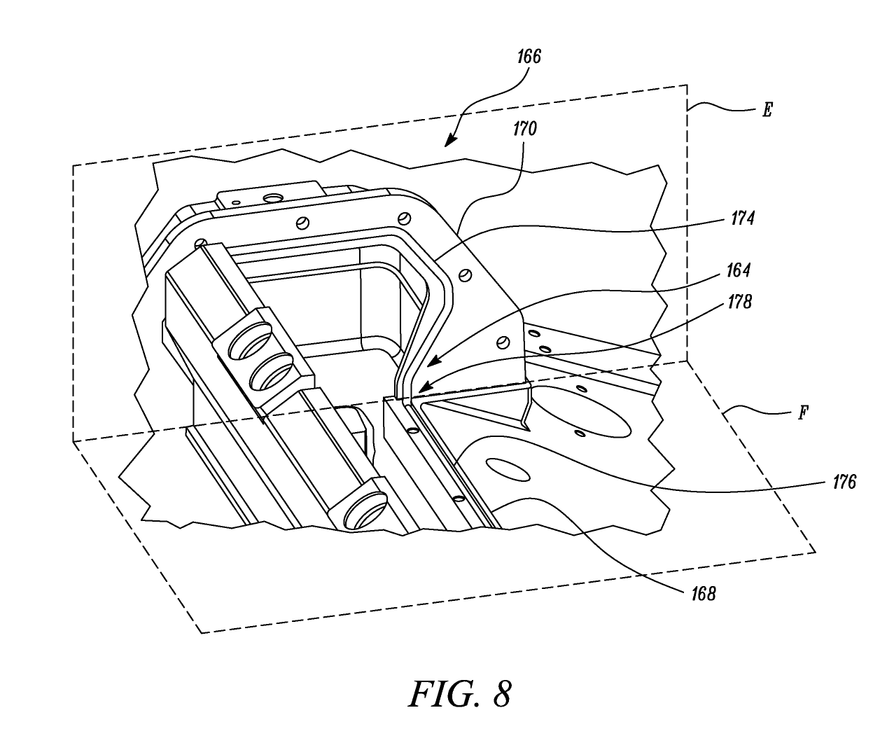

Another application area is shown in FIG. 8, where a sealing structure 164 of a cover assembly 166 associated with a crank case 168 of the engine 100 is depicted. The cover assembly 166 protects sensors that are positioned on top of the crank case 168. The cover assembly 166 may include multiple cover portions, one such cover portion 170 is shown in the accompanying figure. The cover portion 170 and other cover portions (not shown) of the cover assembly 166 may be similar to the cover portions 108, 110 described earlier in this section.

The sealing structure 164 of the cover assembly 166 includes a first sealing member 174 that seals an interface between the cover assembly 166 with the crank case 168. Further, a second sealing member 176 may seal the cover portion 170 with other cover portions of the cover assembly 166. The first and second sealing members 174, 176 may be similar to the first, second, and third sealing members 120, 128, 126 disclosed earlier in this section.

The first sealing member 174 of the cover assembly 166 is provided in a first plane “E” that is perpendicular to a second plane “F” in which the second sealing member 176 is provided. The first and second sealing members 174, 176 provided in the perpendicular planes “E”, “F” may be coupled using a coupling mechanism 178. The coupling mechanism 178 may be similar to the coupling mechanisms 130, 145 described in detail above.

### INDUSTRIAL APPLICABILITY

The present disclosure relates to the coupling mechanism 130, 145, 163, 178 for the sealing structure 116, 158, 164, respectively. The coupling mechanism 130, 145, 163, 178 provides an effective solution by which the sealing members in different planes can interface with each other in a foolproof and easy to assemble/disassemble manner. This section will now be explained in relation to the coupling mechanisms 130, 145 shown in FIGS. 4 and 6. However, it should be understood that the description provided below is equally applicable to the coupling mechanisms 163, 178, without any limitations. As shown in FIGS. 4 and 6, the coupling mechanism 130, 145 includes the male portion 140, 148 that sealingly engages and interlocks with the respective female portion 142, 150 in order to couple the first seal 122 contained in the first plane “A” with the second sealing member 128 contained in the second plane “B”.

Further, the first and the second sealing members 120, 128 of the sealing structure 116 are held in place and provide sealing function due to a slight tension under which the first sealing members 120, contained in the plane “A”, are held. Further, as shown in FIG. 5, the sloped faces 138, 141, 143 of the male portion 140 allows the sealing the first and second seals 122, 124 using the tension in the first seal 122, thereby eliminating the need for using additional mechanisms for clamping the sealing interface. Thus, the coupling mechanism 130, 145 eliminates requirement of adhesives or clamping mechanisms to couple the various sealing members of the sealing structure 116. Also, the coupling mechanism 130, 145 provides an ergonomic and cost-effective solution for addressing problems associated with assembling/disassembling of the various sealing members.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A coupling mechanism for a sealing structure having interacting seals in non-parallel planes, the coupling mechanism comprising:
a male portion of a mechanical joint, the male portion coupled with a first sealing member, the first sealing member contained in a first plane; and
a female portion of the mechanical joint, the female portion coupled with a second sealing member, the second sealing member contained in a second plane, wherein the second plane is different from the first plane,
wherein the male portion is configured to mate with the female portion for coupling the first sealing member with the second sealing member.

2. The coupling mechanism of claim 1, wherein the first plane containing the first sealing member is perpendicular to the second plane containing the second sealing member.

3. The coupling mechanism of claim 1, wherein the coupling mechanism is associated with a sealing structure of an engine rocker arm cover.

4. The coupling mechanism of claim 1, wherein the male portion and the first sealing member are manufactured as a unitary component.

5. The coupling mechanism of claim 1, wherein the female portion and the second sealing member are manufactured as a unitary component.

6. The coupling mechanism of claim 1, wherein the mechanical joint includes at least one of a dovetail joint and a T-joint.

7. The coupling mechanism of claim 1, wherein the mechanical joint is a reverse dovetail joint.

8. The coupling mechanism of claim 1, wherein each of the first and second sealing members is made of an elastomer.

9. The coupling mechanism of claim 1, wherein the female portion includes a socket corresponding to a shape of the male portion of the mechanical joint, the socket being configured to receive the male portion for coupling of the first sealing member with the second sealing member.

10. A sealing structure for a rocker arm cover of an engine, the sealing structure comprising:
a first sealing member contained in a first plane;
a second sealing member configured to couple to the first sealing member, the second sealing member contained in a second plane, wherein the first and second planes are perpendicular to each other; and
a coupling mechanism for coupling the first sealing member with the second sealing member, the coupling mechanism comprising:
a male portion of a mechanical joint, the male portion coupled with the first sealing member; and
a female portion of the mechanical joint, the female portion coupled with the second sealing member,
wherein the male portion is configured to mate with the female portion for coupling the first sealing member with the second sealing member.

11. The sealing structure of claim 10, wherein the male portion and the first sealing member are manufactured as a unitary component.

12. The sealing structure of claim 10, wherein the female portion and the second sealing member are manufactured as a unitary component.

13. The sealing structure of claim 10, wherein the mechanical joint includes at least one of a dovetail joint and a T-joint.

14. The sealing structure of claim 10, wherein the female portion includes a socket corresponding to a shape of the male portion of the mechanical joint, the socket being configured to receive the male portion for coupling of the first sealing member with the second sealing member.

15. An engine comprising:
a rocker arm cover having a first cover portion and a second cover portion; and
a sealing structure configured to couple at least one of the first cover portion with the second cover portion and the rocker arm cover with a surface of the engine, the sealing structure comprising:
a first sealing member contained in a first plane;
a second sealing member configured to couple to the first sealing member, the second sealing member contained in a second plane, wherein the first and second planes are perpendicular to each other; and
a coupling mechanism for coupling the first sealing member with the second sealing member, the coupling mechanism comprising:
a male portion of a mechanical joint, the male portion coupled with the first sealing member; and
a female portion of the mechanical joint, the female portion coupled with the second sealing member,
wherein the male portion is configured to mate with the female portion for coupling the coupling the first sealing member with the second sealing member.

16. The engine of claim 15, wherein the male portion and the first sealing member are manufactured as a unitary component.

17. The engine of claim 15, wherein the female portion and the second sealing member are manufactured as a unitary component.

18. The engine of claim 15, wherein the mechanical joint includes at least one of a dovetail joint and a T-joint.

19. The engine of claim 15, wherein each of the first and second sealing members is made of an elastomer.

20. The engine of claim 15, wherein the female portion includes a socket corresponding to a shape of the male portion of the mechanical joint, the socket being configured to receive the male portion for coupling of the first sealing member with the second sealing member.
